(19) United States
(12) Patent Application Publication
(10) Pub. No.: US 2018/0286186 A1
(43) Pub. Date: Oct. 4, 2018

(54) CASH DRAWER AND PAYMENT APPARATUS INCLUDING THE SAME

(71) Applicant: BSM CASH DRAWER CO., LTD., Paju-si (KR)

(72) Inventors: Jung Woo CHO, Goyang-si (KR); Sung Woo CHO, Seoul (KR)

(21) Appl. No.: 15/942,828

(22) Filed: Apr. 2, 2018

(30) Foreign Application Priority Data
Apr. 3, 2017 (KR) 10-2017-0043097

(51) Int. Cl. G07G 1/00; G07G 1/12; G06Q 20/20

(52) U.S. Cl. CPC G07G 1/0027; G06Q 20/20; G07G 1/12

(57) ABSTRACT

Provided are a cash drawer having an improved user convenience and a payment apparatus including the cash drawer. The cash drawer includes a tray configured to contain cash or receipts therein, a housing configured to accommodate the tray and having a first opening in a first side thereof such that the tray slides out through the first opening to expose at least a part of an inner portion of the tray to outside of the housing or the tray slides into the first opening to completely block the inner portion of the tray from the outside of the housing, and a display located at a second side of the housing.

### CROSS-REFERENCE TO RELATED APPLICATION

This application claims the benefit of Korean Patent Application No. 10-2017-0043097, filed on Apr. 3, 2017, in the Korean Intellectual Property Office, the disclosure of which is incorporated herein in its entirety by reference.

### BACKGROUND

### 1. Field

One or more embodiments relate to a cash drawer and a payment apparatus including the cash drawer, and more particularly, to a cash drawer having improved user convenience and a payment apparatus including the cash drawer.

### 2. Description of the Related Art

In general, a payment apparatus includes a payment terminal and a cash drawer depositing and drawing cash. Therefore, the above components are provided on a counter, where credit card payments and/or cash receipts and disbursements are performed, and a seller or a service-provider (hereinafter, referred to as “seller”) and a service user (hereinafter, referred to as “consumer”), who pays with a credit card or cash, may use the payment apparatus.

However, according to the payment apparatus of the related art, it is not easy for the consumer to check a payment statement, or the payment apparatus has a complicated structure allowing the consumer to check the payment statement.

### SUMMARY

One or more embodiments include a cash drawer having improved user convenience and a payment apparatus including the cash drawer.

Additional aspects will be set forth in part in the description which follows and, in part, will be apparent from the description, or may be learned by practice of the presented embodiments.

According to one or more embodiments, a cash drawer includes: a tray configured to contain cash or receipts therein; a housing configured to accommodate the tray, the housing having a first opening in a first side thereof such that the tray slides out through the first opening to expose at least a part of an inner portion of the tray to outside of the housing or the tray slides into the first opening to completely block the inner portion of the tray from the outside of the housing; and a display located at a second side of the housing.

The second side may be opposite the first side, the housing may have a second opening in the second side thereof, and the display may be mounted in the second opening. A rear plate having the second opening of the housing may not be perpendicular to an upper plate of the housing. An angle formed by the rear plate having the second opening and the upper plate of the housing, within a space where the tray is accommodated, may be an obtuse angle.

The cash drawer may further include an information processor configured to receive payment-related information data from a payment terminal, wherein the display may display payment-related information by using the payment-related information data received by the information processor. The cash drawer may further include a payment means reader configured to recognize payment means information, wherein, when the information processor receives the payment-related information data, the display may display the payment-related information by using the payment-related information data received by the information processor and the payment means reader is activated to recognize the payment means information.

When the information processor receives payment completion information data from the payment terminal, the tray may slide out to expose at least a part of the inner portion of the tray to the outside of the housing, and the display may display payment completion information by using the payment completion information data received by the information processor.

The cash drawer may further include a proximity sensor mounted in a third opening, wherein the third opening is provided in the rear plate of the housing, the rear plate having the second opening. When the proximity sensor senses a person approaching, the display may display an image set in advance.

The cash drawer may further include a sterilizing device located inside the housing and configured to irradiate ultraviolet rays or emit plasma ions towards the inner portion of the tray when the inner portion of the tray may be completely blocked from the outside of the housing. The display may display an image indicating that the sterilizing device is in operation, while the sterilizing device operates.

The cash drawer may further include a speaker located under the display and configured to reproduce sound related to an image displayed by the display.

The display may have a touch-screen function.

### BRIEF DESCRIPTION OF THE DRAWINGS

These and/or other aspects will become apparent and more readily appreciated from the following description of the embodiments, taken in conjunction with the accompanying drawings in which:

FIG. 1 is a perspective view of a cash drawer according to an embodiment;

FIG. 2 is a cross-sectional view taken along a line II-II of FIG. 1;

FIG. 3 is a schematic cross-sectional view of a cash drawer according to another embodiment;

FIG. 4 is a schematic cross-sectional view of a cash drawer according to another embodiment;

FIG. 5 is a schematic cross-sectional view of a cash drawer according to another embodiment; and

FIG. 6 is a schematic cross-sectional view of a cash drawer according to another embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items.

As the present disclosure allows for various changes and numerous embodiments, particular embodiments will be illustrated in the drawings and described in detail in the written description. The attached drawings for illustrating one or more embodiments are referred to in order to gain a sufficient understanding, the merits thereof, and the objectives accomplished by the implementation. However, the embodiments may have different forms and should not be construed as being limited to the descriptions set forth herein.

The exemplary embodiments will be described below in more detail with reference to the accompanying drawings. Those components that are the same or are in correspondence are rendered the same reference numeral regardless of the figure number, and redundant explanations are omitted.

It will be understood that when an element such as a layer, film, region or substrate is referred to as being placed “on” another element, it can be directly placed on the other element, or an intervening layer(s) may also be present. Sizes of components in the drawings may be exaggerated for convenience of explanation. In other words, since sizes and thicknesses of components in the drawings are arbitrarily illustrated for convenience of explanation, the following embodiments are not limited thereto.

The x-axis, the y-axis and the z-axis are not limited to three axes of the rectangular coordinate system, and may be interpreted in a broader sense. For example, the x-axis, the y-axis, and the z-axis may be perpendicular to one another, or may represent different directions that are not perpendicular to one another.

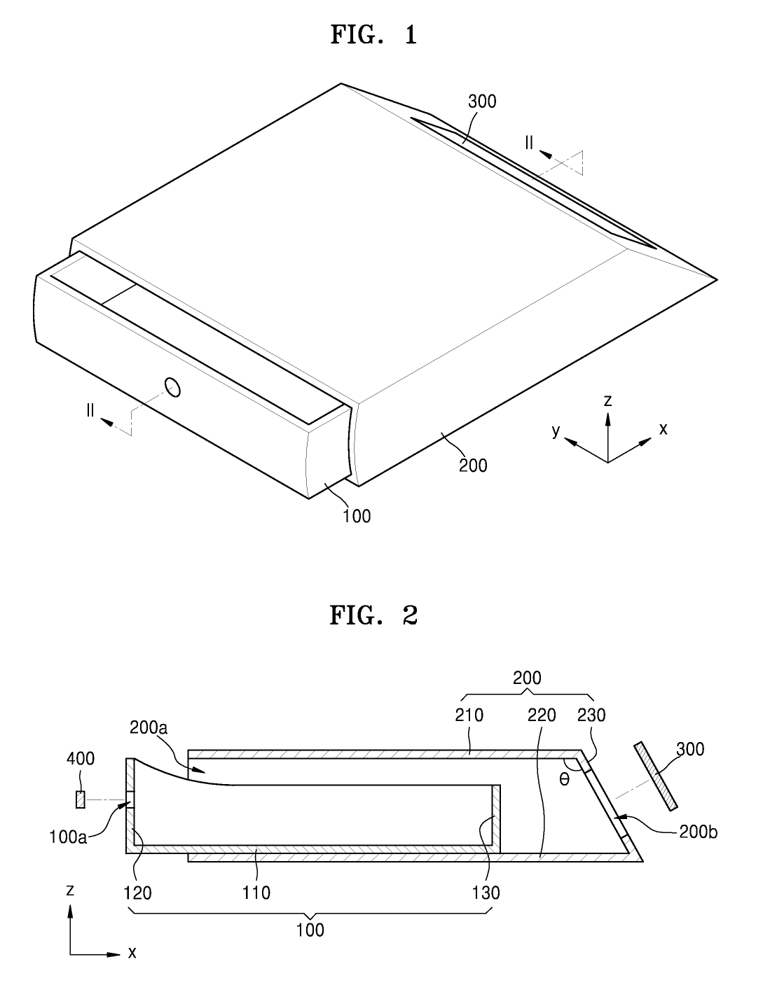

FIG. 1 is a schematic perspective view of a cash drawer according to an embodiment, and FIG. 2 is a schematic cross-sectional view taken along a line II-II of FIG. 1. As shown in FIGS. 1 and 2, the cash drawer according to the present embodiment includes a tray 100, a housing 200, and a display 300.

The tray 100 includes a first lower plate 110, a first front plate 120 located at a side (in −x direction) and connected to the first lower plate 110, a first rear plate 130 located at an opposite side (in +x direction) and connected to the first lower plate 110, and two first side plates (not shown) connected to the first lower plate 110 for connecting the first front plate 120 to the first rear plate 130. The tray 100 may store money or receipts therein.

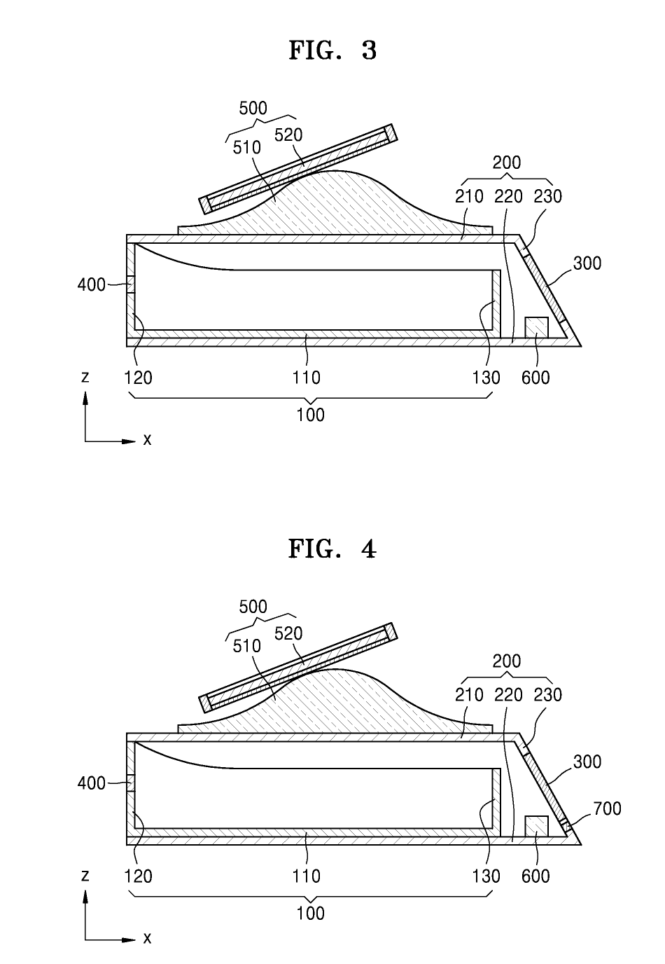

The tray 100 is at least partially accommodated in the housing 200 configuring an entire outer appearance of the cash drawer. In detail, the housing 200 has an empty space to accommodate the tray 100, and a first opening 200a in a first side thereof (in the −x direction) so that the tray 100 may slide out and at least a partial inner space of the tray 100 may be exposed to the outside. The tray 100 may slide into the housing 200 so that the first front plate 120 shields the first opening 200a of the housing 200, and in this case, an entire inner portion of the tray 100 is located in the housing 200 (see FIG. 3). That is, the housing 200 may allow the at least a partial inner portion of the tray 100 to be exposed to the outside or allow the inner portion of the tray 100 to be completely blocked from the outside.

The housing 200 includes a second lower plate 220, a second upper plate 210 above the second lower plate 220, a second rear plate 230 at a second side (in the +x direction) for connecting the second lower plate 220 to the second upper plate 210, and two second side plates (not shown) connected to the second rear plate 230 and connecting the second lower plate 220 to the second upper plate 210. The housing 200 may include a guide rail (not shown) therein, and thus, the tray 100 may slide along the guide rail. The guide rail may be located between the second lower plate 220 of the housing 200 and the first lower plate 110 of the tray 100, or may be located between the second side plates of the housing 200 and the first side plates of the tray 100.

The display 300 may be located in the second side (in the +x direction) of the housing 200. In detail, the second rear plate 230 of the housing 200 includes a second opening 200b, and the display 300 may be provided in the second opening 200b.

When the cash drawer according to the embodiment is used, the first opening 200a of the housing 200 is located towards the seller and the display 300 is located towards the consumer. Therefore, various information is displayed on the display 300, and thus, the consumer may easily check the information. In particular, the display is not separately provided, but is located on the cash drawer that is an essential element of the payment apparatus. Thus, consumer's convenience in checking information may be greatly improved while simplifying a structure of the payment apparatus.

The information displayed by the display 300 in the cash drawer may be information regarding goods or services provided in a store managed by the seller, or general information such as weather information that the consumer may be interested in. Otherwise, the information may include a text for welcoming the consumer, that is, may be variously modified.

Also, when the cash drawer includes an anti-theft device, the display 300 may display information regarding the anti-theft device. For example, when the cash drawer is sensed to be out of a set location through a magnetic sensor module that senses robbery when a first magnet mounted on a table, etc. and a second magnet attached to a main body of the cash drawer are separated, the display 300 may display the information notifying robbery. In this case, when the cash drawer includes a speaker as will be described later, sound related to the position escape of the cash drawer may be generated simultaneously through the speaker. Also, when the cash drawer includes an information transmitter, information regarding the position escape of the cash drawer may be transmitted to a mobile phone that is designated in advance. In this case, when the first magnet and the second magnet are connected to each other again, the display 300 may stop displaying the information regarding the robbery.

In addition, the cash drawer is generally located lower than the eyes of the seller and the consumer. Therefore, the second rear plate 230 having the second opening 200b of the housing 200 may not be perpendicular to the second upper plate 210 of the housing 200. In detail, an angle (0) formed by the second rear plate 230 having the second opening 200b and the second upper plate 210 of the housing 200 in the space where the tray 100 is accommodated may be an obtuse angle. As such, a surface of the display 300 of the cash drawer may face the consumer, and thus, the consumer may easily recognize the display surface of the display 300. In particular, since the consumer is around the second rear plate 230 of the cash drawer during the payment, when the angle between the second rear plate 230 having the second opening 200b in the housing 200 and the second upper plate 210 of the housing 200 is an obtuse angle, eyes of the consumer higher than the cash drawer naturally see the information displayed on the display 300.

FIG. 3 is a schematic cross-sectional view of a cash drawer according to an embodiment. The cash drawer according to the embodiment further includes an information processor 600 that receives information data related to the payment from a payment terminal 500.

The information processor 600 may be located, for example, in the housing 200. To do this, the second lower plate 220 of the housing 200 may have an area that is greater than that of the first lower plate 110 of the tray 100. Accordingly, when the tray 100 slides into the housing 200, the first front plate 120 of the tray 100 closes the first opening 200a of the housing 200, and the entire inner portion of the tray 100 is located in the housing 200, a space may exist between the first rear plate 130 of the tray 100 and the second rear plate 230 of the housing 200. The information processor 600 may be located in the space. Accordingly, the cash drawer may have various functions while simplifying the outer appearance thereof. The display 300 may display information regarding the payment by using the information data regarding the payment received by the information processor 600.

When the cash drawer according to the embodiment is used, the first opening 200a of the housing 200 is located towards the seller and the display 300 is located towards the consumer. Therefore, the display 300 displays the payment statement during the payment process, and thus, the consumer may easily check the payment statement. In particular, the display is not separately provided, but is located on the cash drawer that is an essential element of the payment apparatus. Thus, consumer's convenience may be greatly improved while simplifying a structure of the payment apparatus.

In addition, the cash drawer is generally located lower than the eyes of the seller and the consumer. Therefore, the second rear plate 230 having the second opening 200b of the housing 200 may not be perpendicular to the second upper plate 210 of the housing 200. In detail, an angle (8) formed by the second rear plate 230 having the second opening 200b and the second upper plate 210 of the housing 200 in the space where the tray 100 is accommodated may be an obtuse angle. As such, a surface of the display 300 of the cash drawer may face the consumer, and thus, the consumer may easily recognize payment-related information displayed on the display 300. In particular, since the consumer is located around the second rear plate 230 of the cash drawer during the payment, when the angle between the second rear plate 230 having the second opening 200b in the housing 200 and the second upper plate 210 of the housing 200 is an obtuse angle, the eyes of the consumer higher than the cash drawer naturally see the payment-related information displayed on the display 300.

The payment terminal 500 may include a supporter 510 and a payment pad 520. The payment pad 520 may be a smart pad or a smartphone. Here, the smart pad denotes a device having a screen and loading a mobile operating system therein, for example, iPad by Apple, Inc., Galaxy Tab by Samsung Electronics Co., Ltd., etc., and may be also referred to as a tablet PC. The payment terminal 500 is not limited thereto, and may include various devices such as a POS terminal, etc.

When the information processor 600 receives payment-related information data from the payment terminal 500, the display 300 displays the payment-related information. The consumer may provide a credit card and/or cash to the seller after checking the payment-related information displayed on the display 300 of the cash drawer, and then, the payment is made. Accordingly, when the payment is finished, the information processor 600 may receive payment completion information data from the payment terminal 500. When the information processor 600 receives the payment completion data from the payment terminal 500, the tray 100 slides in the −x direction so that the inner portion of the tray 100 may be at least partially exposed to an outer portion of the housing 200, and the display 300 may display payment completion information by using the payment completion information data received by the information processor 600.

The tray 100 may have an opening 100a (see FIG. 2) or a groove in the first front plate 120 facing the seller, and a button 400 may be located in the opening 100a or the groove. Accordingly, when the seller pushes the button 400, the tray 100 slides in the −x direction so that the inner portion of the tray 100 is at least partially exposed to the outer portion of the housing 200, and the display 300 may display the payment completion information by using the payment completion information data received by the information processor 600.

When the cash drawer according to the embodiment is used, the first opening 200a of the housing 200 is located towards the seller and the display 300 is located towards the consumer. Therefore, the payment completion information is displayed on the display 300 when the payment is finished, and thus, the consumer may easily check the payment completion information. In particular, the display 300 is not separately provided, but is located on the cash drawer that is an essential element of the payment apparatus. Thus, consumer's convenience may be greatly improved while simplifying a structure of the payment apparatus.

FIG. 4 is a schematic cross-sectional view of a cash drawer according to an embodiment. The cash drawer according to the embodiment further includes a proximity sensor 700. Here, the second rear plate 230 having the second opening 200b (see FIG. 2) of the housing 200 further includes a third opening, and the proximity sensor 700 may be mounted in the third opening.

The cash drawer according to the embodiment may display an image set in advance on the display 300, when the proximity sensor 700 senses a person approaching. Here, the image displayed by the display 300 in the cash drawer may include information regarding goods or services provided in a store managed by the seller, or general information such as weather information that the consumer may be interested in. Otherwise, the image may include a text for welcoming the consumer, that is, may be variously modified. In this case, the proximity sensor 700 may sense a body temperature of a human being, or may directly sense an object approaching.

Alternatively, when a case having bills and/or accounts therein, wherein the case is carried by the consumer, has a radio frequency identification (RFID) or near field communication (NFC) function, the proximity sensor 700 may receive information via RFID or NFC. As such, when the consumer approaches the cash drawer with the corresponding case, the proximity sensor 700 may sense the case carried by the consumer by using RFID and/or NFC. In addition, details that the consumer has to pay may be automatically displayed on the display 300 of the cash drawer, and thus, convenience of the seller and the consumer may be greatly improved.

To do this, the information processor 600 may have an information transmission function, in addition to the information receiving function. Accordingly, information of the case carried by the consumer and sensed by the proximity sensor 700 is transmitted to the payment terminal 500, etc. by the information processor 600, the information processor 600 receives payment-related information from the payment terminal 500, and the information processor 600 transmits the received information to the display 300 so that the display 300 may display the information. The information processor 600 may include a controller, a transmitter, and a receiver. This will be applied to embodiments described below and modified examples thereof.

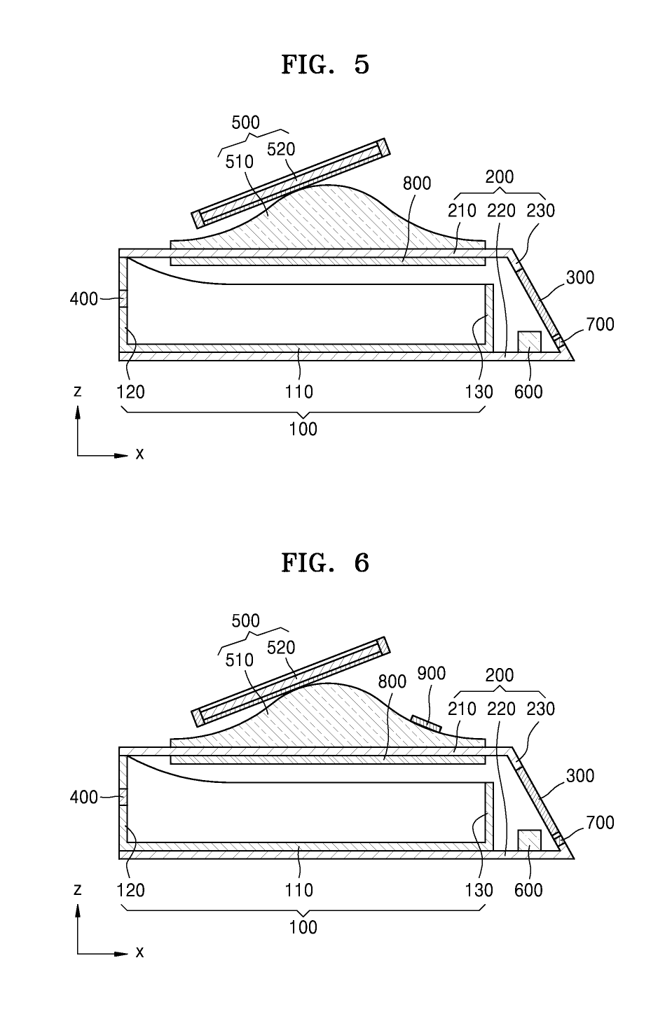

FIG. 5 is a schematic cross-sectional view of a cash drawer according to an embodiment. The cash drawer according to the embodiment further includes a sterilizing device 800. The sterilizing device 800 may be located in the housing 200, and in detail, may be located on the second upper plate 210 of the housing 200. Accordingly, the tray 100 slides into the housing 200 to make the first front plate 120 close the first opening 200a of the housing 200, and then, the entire inner portion of the tray 100 is located in the housing 200. Thus, the sterilizing device 800 faces the inner space of the tray 100.

The sterilizing device 800 emits ultraviolet rays or plasma ions to sterilize a target. In particular, when the inner portion of the tray 100 is completely blocked from the outside, the sterilizing device 800 may irradiate ultraviolet rays or may emit plasma ions towards the inner space of the tray 100.

Cash is frequently used during the payment process, and is likely to be at least partially contaminated while going from hand to hand of many people. For example, cash may contain a variety of bacteria and/or viruses. Therefore, when the inner portion of the tray 100 is completely blocked from the outer portion of the housing 200, the sterilizing device 800 may irradiate ultraviolet rays or emit plasma ions towards the inner space of the tray 100, and thus, cash stored in the tray 100 may be effectively sterilized. In addition, when the sterilizing device 800 operates, the display 300 may display an image indicating that the sterilizing device 800 is in operation, so that the consumer may directly recognize the sterilization.

In addition, the cash drawer may further include a speaker (not shown). The speaker may be located at a lower end of the display 300, and may reproduce sound related to the image displayed by the display 300. That is, when the display 300 displays information regarding goods or services provided in the store managed by the seller, the speaker may reproduce the sound related to the information. In addition, when the display 300 displays general information such as weather information that the consumer would be interested in, the speaker may also reproduce sound related to the general information. Also, when the display 300 displays information such as text for welcoming consumers, the speaker may also reproduce sound related to the information. When the display 300 displays payment-related information, the speaker reproduces sound related to the information, and thus, the convenience of the consumer may be greatly improved.

In addition, in the embodiments described above, the display 300 may have a touch-screen function. As such, the consumer may not only check the payment-related information through the display 300, but also input payment-related information such as a signature by using the touch-screen function of the display 300.

FIG. 6 is a schematic cross-sectional view of a cash drawer according to an embodiment of the present disclosure, and as shown in FIG. 6, the cash drawer may further include a payment means reader 900. The payment means reader 900 may be located at the consumer side, that is, a side where the display 300 is located.

After checking the payment-related information on the display 300, the consumer may transfer payment means information to the cash drawer via the payment means reader 900 in a way of bringing the payment means such as a credit card into contact with the payment means reader 900 or approaching the payment means around the payment means reader 900. The payment means information may be transferred to the payment terminal 500 directly or via the information processor 600, and thus, the payment may be made. When the payment is finished, the information processor 600 may receive payment completion information data from the payment terminal 500. When the information processor 600 receives the payment completion information data from the payment terminal 500, the display 300 may display payment completion information by using the payment completion information data received by the information processor 600.

The payment means recognized by the payment means reader 900 is not limited to credit cards including an IC card, an MSR card, etc. For example, the payment means reader 900 may recognize a payment means such as Apple Pay™, Samsung Pay™, Google Pay™, etc., or various payment means using the RFID or NFC function.

In addition, when the cash drawer includes the proximity sensor 700, there is no need to maintain an activation state of the payment means reader 900. For example, the payment means reader 900 is in an inactivated state normally, and when the proximity sensor 700 senses the consumer approaching the cash drawer, the payment means reader 900 may be controlled to be activated via the information processor 600 based on a sensing signal. Alternately, the payment means reader 900 is normally in an inactivated state, and when the information processor 600 receives payment-related information data from the payment terminal 500, the display 300 may be controlled to display the payment-related information and the payment means reader 900 is activated.

According to the embodiment of the present disclosure, the cash drawer having an improved user convenience and the payment apparatus including the cash drawer may be implemented. However, the scope of the invention is not limited to the above effects.

The cash drawer is described as above, but the present disclosure is not limited thereto. For example, a cash drawer according to one of the above-described embodiments and modified examples thereof and a payment apparatus including a payment terminal capable of exchanging payment-related information data with the cash drawer may be also included in the scope of the present disclosure.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope of the disclosure as defined by the following claims.

What is claimed is:

1. A cash drawer comprising:
a tray configured to contain cash or receipts therein;
a housing configured to accommodate the tray, the housing having a first opening in a first side thereof such that the tray slides out through the first opening to expose at least a part of an inner portion of the tray to outside of the housing or the tray slides into the first opening to completely block the inner portion of the tray from the outside of the housing; and
a display located at a second side of the housing.

2. The cash drawer of claim 1, wherein the second side is opposite the first side, the housing has a second opening in the second side thereof, and the display is mounted in the second opening.

3. The cash drawer of claim 2, wherein a rear plate having the second opening of the housing is not perpendicular to an upper plate of the housing.

4. The cash drawer of claim 3, wherein an angle formed by the rear plate having the second opening and the upper plate of the housing, within a space where the tray is accommodated, is an obtuse angle.

5. The cash drawer of claim 1, further comprising an information processor configured to receive payment-related information data from a payment terminal,
wherein the display displays payment-related information by using the payment-related information data received by the information processor.

6. The cash drawer of claim 5, further comprising a payment means reader configured to recognize payment means information,
wherein, when the information processor receives the payment-related information data, the display displays the payment-related information by using the payment-related information data received by the information processor and the payment means reader is activated to recognize the payment means information.

7. The cash drawer of claim 5, wherein, when the information processor receives payment completion information data from the payment terminal, the tray slides out to expose at least a part of the inner portion of the tray to the outside of the housing, and the display displays payment completion information by using the payment completion information data received by the information processor.

8. The cash drawer of claim 1, further comprising a proximity sensor mounted in a third opening, wherein the third opening is provided in the rear plate of the housing, the rear plate having the second opening.

9. The cash drawer of claim 8, wherein, when the proximity sensor senses a person approaching, the display displays an image set in advance.

10. The cash drawer of claim 1, further comprising a sterilizing device located inside the housing and configured to irradiate ultraviolet rays or emit plasma ions towards the inner portion of the tray when the inner portion of the tray is completely blocked from the outside of the housing.

11. The cash drawer of claim 10, wherein the display displays an image indicating that the sterilizing device is in operation, while the sterilizing device operates.

12. The cash drawer of claim 1, further comprising a speaker located under the display and configured to reproduce sound related to an image displayed by the display.

13. The cash drawer of claim 1, wherein the display has a touch-screen function.

14. A payment apparatus comprising:
the cash drawer of claim 1; and
a payment terminal configured to exchange information data regarding payment with the cash drawer.
